(19) United States
(12) Patent Application Publication
(10) Pub. No.: US 2022/0125058 A1
(43) Pub. Date: Apr. 28, 2022

(54) APPLICATION OF ATRACTYLODES LANCEOLATA ESSENTIAL OIL

(71) Applicant: SOUTHWEST UNIVERSITY, Chongqing (CN)

(72) Inventors: Yingjuan CHEN, Chongqing (CN); Yuhe WAN, Chongqing (CN); Huarong TONG, Chongqing (CN); Junqing HUANG, Chongqing (CN); Zheng ZHANG, Chongqing (CN)

(21) Appl. No.: 17/447,090

(22) Filed: Sep. 8, 2021

(30) Foreign Application Priority Data
Oct. 27, 2020 (CN) 202011161543.3

(51) Int. Cl. A01N 65/12; A01N 25/04

(52) U.S. Cl. CPC A01N 65/12; A01N 25/04

(57) ABSTRACT

The present invention provides an application of Atractylodes lanceolata essential oil, which is used for the prevention and treatment of Pseudopestalotiopsis camelliae sinensis. The Atractylodes lanceolata essential oil of the present invention has a good inhibitory effect on Pseudopestalotiopsis camelliae sinensis, and can be developed and used as a new type of plant-derived fungicide.

### CROSS REFERENCE TO RELATED APPLICATION(S)

This patent application claims the benefit and priority of Chinese Patent Application No. 202011161543.3, filed on Oct. 27, 2020, the disclosure of which is incorporated by reference herein in its entirety as part of the present application.

### TECHNICAL FIELD

The present invention belongs to the technical field of prevention and treatment of tea tree diseases, and specifically relates to the application of Atractylodes lanceolata essential oil.

### BACKGROUND ART

Gray blight disease caused by Pseudopestalotiopsis camelliae-sinensis is one of the main leaf diseases that damage tea trees. It is widely occurred in tea plantations in our country and widely exists in various tea producing areas. It harms the development of the tea industry to varying degrees in different regions, and can cause large areas of tea leave necrosis and tea leaves falling off in severe cases, which affects the vigor of the tree and the yield and quality of tea. Pestalotiopsis-like species are considered to be the pathogens of tea gray blight disease. At present, the main measures for the prevention and treatment of tea plant diseases in tea plantations use chemical fungicides, which occupy a very important position. However, chemical fungicides have the characteristics of environmental pollution and easy resistance. Therefore, it is necessary to find efficient, safe, and environmentally friendly fungicides for tea diseases prevention and treatment. Plant-derived fungicides refer to plant active ingredients with fungicidal and antifungal activity or isolated and purified monomeric substances for the prevention and treatment of plant diseases. As an important part of biological fungicides, it is a hot spot in the research and development of new fungicides. Our country has abundant plant resources and unique plant species, and the prospects for the development and utilization of plant resources for disease control are very broad.

### SUMMARY

The technical problem to be solved by the present invention is to provide an application of Atractylodes lanceolata essential oil in view of the above-mentioned shortcomings of the prior art. The Atractylodes lanceolata essential oil has a good inhibitory effect on Pseudopestalotiopsis camelliae-sinensis and can be used as a new type of plant-derived fungicides development and use.

In order to solve the above technical problems, the technical solution employed by the present invention is: an application of Atractylodes lanceolata essential oil, which is used for the prevention and treatment of Pseudopestalotiopsis camelliae-sinensis.

Preferably, EC₅₀ of the laboratory virulence of the Atractylodes lanceolata essential oil on Pseudopestalotiopsis camelliae-sinensis is 0.269 mg/mL.

Compared with the prior art, the present invention has the following advantages:

The Atractylodes lanceolata essential oil of the invention has a good inhibitory effect on Pseudopestalotiopsis camelliae-sinensis, and can be developed and used as a new plant-derived fungicides.

The present invention will be further described in detail below with reference to the embodiments.

### DETAILED DESCRIPTION OF THE EMBODIMENTS

In the application of the Atractylodes lanceolata essential oil in this embodiment, the Atractylodes lanceolata essential oil is used for the prevention and treatment of Pseudopestalotiopsis camelliae-sinensis; EC₅₀ of the laboratory virulence of the Atractylodes lanceolata essential oil on Pseudopestalotiopsis camelliae-sinensis is 0.269 mg/mL.

### Example 1

The Atractylodes lanceolata essential oil was obtained by steam distillation. The specific method was as follows:

200 g of Atractylodes powder was filtered through a 26-mesh sieve and placed in a 5000-mL round-bottomed flask. 3000 mL of water was added and the powder was allowed to soak overnight, and then was heated on a thermostatic electric heating mantle to boil and extract for 6 hours, then heating was stopped. The condensed water flowed back to the extractor for cooling until no liquid flowed down from the condenser to collect the Atractylodes lanceolata essential oil.

(1) Laboratory virulence determination of the Atractylodes lanceolata essential oil on Pseudopestalotiopsis camelliae-sinensis

A small amount of dimethyl sulfoxide was added to Atractylodes lanceolata essential oil, and then diluted with sterilized distilled water to obtain a medicinal solution. The fungicides were added to the PDA medium to prepare the Atractylodes lanceolata essential oil 1 at concentrations of 0.10, 0.50, 0.75, 1.00 mg/mL drug-containing medium, and PDA medium without medicament as a control. Each treatment was repeated 3 times. After 5 days of cultivation of the pathogen, a punch with a diameter of 5 mm was used to punch out the fungus block, followed by inoculation to the center of each fungicide-containing medium and the control PDA medium, and then the fungal colony-containing side was fully contact the medium and incubated for 7 days in a constant temperature incubator at 25±2° C. The fungal colony diameter was then measured by the cross method and the average value taken. The SPSS software was used to calculate the inhibition rate, toxicity regression equation and the EC₅₀ value. The determination results are shown in Table 1, indicating that the Atractylodes lanceolata essential oil has a significant inhibition rate on Pseudopestalotiopsis camelliae-sinensis. When the concentration was 1.00 mg/mL, the inhibition rate was 100%.

Inhibition Rate Calculation Formula:

Inhibition rate=(Control colony diameter−Treated colony diameter)/Control colony diameter×100%

TABLE 1
Laboratory virulence of the atractylodes lanceolata essential
oil on Pseudopestalotiopsis camelliae-sinensis

| | Concen- | | Toxicity | | |
|---|---|---|---|---|---|
| | tration | Inhibition | regression | Correlation | EC₅₀ |
| Fungicide | (mg/mL) | rate (%) | equation | coefficient | (mg/mL) |
| Atractylodes | 0.10 | 22.67 | y = | 0.986 | 0.269 |
| lanceolata | 0.50 | 60.00 | 2.068 ×+ | | |
| essential oil | 0.75 | 76.00 | 6.180 | | |
| | 1.00 | 100.00 | | | |

(2) Field antifungal effect of Atractylodes lanceolata oil on Pseudopestalotiopsis camelliae-sinensis

Sixty healthy tea seedlings were selected from 1-2 years old, and the pathogen of rotifer was formulated into a conidia suspension of 1×10⁶ spores/mL to spray the healthy tea seedlings. Then the tea seedlings treated with pathogen were divided into two groups, namely the treatment group and the clear water control group, each group containing 30 tea seedlings. At the early stage of the occurrence of tea gray blight disease, the treatment group was sprayed with 1.00 mg/mL Atractylodes essential oil aqueous solution, and the clear water control group was treated with clear water. In the peak period of the disease, the disease index and the control effect were calculated according to the disease status of tea leaves. The classification standards were as follows:

TABLE 2
Classification standards of tea gray blight disease

| Degree | Symptom |
|---|---|
| 0 degree | Anosis |
| 1 degree | 1 to 2 lesions on the leaf |
| 2 degree | 3 to 4 lesions on the leaves or less than two-third |
| | of the leaf area |
| 3 degree | 5 to 7 lesions on the leaves or a half of the leaf area |
| 4 degree | More than 8 lesions on the leaves or more than |
| | two-third of the leaf area, or there are lesions |
| | on petioles or tender leaves |

The formula for calculating the disease index was:

Disease index=100×Σ(Number of diseased leaves at each degree×Representative value of each degree)/(Total number of leaves in investigation×Representative value of highest degree1)

Control effect (%)=100×(Disease index of control area−Disease index of the treatment area)/Disease index of clear water control group.

TABLE 3
Field control effect of Atractylodes lanceolata essential
oil on Pseudopestalotiopsis camelliae-sinensis

| Treatment | Disease index | Control effect (%) |
|---|---|---|
| Atractylodes lanceolata | 1.83 | 91.93 |
| essential oil | | |
| Clear water control group | 22.67 | — |

Note: “—” means no investigation has been done.

It can be seen from Table 3 that the use of Atractylodes lanceolata essential oil to prevent and treat Pseudopestalotiopsis camelliae-sinensis can achieve 91.93% of the control effect, which has a good control effect.

The above are merely preferred embodiments of the present invention, but do not impose any limitation on the present invention. Any simple modifications, alterations and equivalent changes made to the above embodiments based on the technical essence of the invention still fall within the protection scope of the technical solution of the present invention.

What is claimed is:

1. An application of Atractylodes lanceolata essential oil, wherein the Atractylodes lanceolata essential oil is used for the prevention and treatment of Pseudopestalotiopsis camelliae-sinensis.

2. The application of Atractylodes lanceolata essential oil according to claim 1, wherein EC₅₀ of laboratory virulence of the Atractylodes lanceolata essential oil to Pseudopestalotiopsis camelliae-sinensis measured is 0.269 mg/mL.
